(19) United States
(12) Patent Application Publication
(10) Pub. No.: US 2017/0313237 A1
(43) Pub. Date: Nov. 2, 2017

(54) An Illumination Standard Calculation Method And System for A Tunnel Middle Section Based On Safe Visual Recognition

(71) Applicants: Beijing University Of Technology (CN), Beijing (CN); Guizhou Expressway Group Co., Ltd. (CN), Guizhou (CN)

(72) Inventors: Jiangbi HU, Beijing (CN); Meng WANG, Beijing (CN); Guiping GUAN, Beijing (CN); Mingyu XIE, Beijing (CN); Xiangzhen CHANG, Beijing (CN); Xiaoqin ZHANG, Beijing (CN); Da GUO, Beijing (CN); Wenqian MA, Beijing (CN); Yuanfeng ZHANG, Beijing (CN); Xiaoyu LI, Beijing (CN); Linxi GAO, Beijing (CN); Xiaojuan GAO, Beijing (CN); Feng LIU, Beijing (CN)

(21) Appl. No.: 15/520,562

(22) PCT Filed: Oct. 15, 2015
(86) PCT No.: PCT/CN2015/091964

§ 371 Date: Apr. 20, 2017

(30) Foreign Application Priority Data
Oct. 26, 2014 (CN) 201410576996.0

(51) Int. Cl. B60Q 1/14; H05B 37/02; G06K 9/00

(52) U.S. Cl. CPC B60Q 1/143; G06K 9/00825; H05B 37/0218

(57) ABSTRACT

This invention relates to an illumination standard calculation method for a tunnel middle section based on safe visual recognition: (a) Setting the light environment of the tunnel middle section; (b) Placing a target object in the tunnel middle section; (c) Making a driver drive a motor vehicle at different speeds toward the target object, and measuring the visual recognition distances D required by the driver to visually discover the target object at different speeds; (d) Resetting the average brightness L of the tunnel middle section and repeating the steps (b) and (c) to obtain a plurality of different sets of visual recognition distances D and corresponding brightness values L; (e) Using the S model to fit the data of the plurality of sets of visual recognition distances D and brightness values L to obtain the formula of the relational model of D and L to be L=0.683/(5.575-In(D)); (f) Substituting a safe stopping sight distance D₀ corresponding to a maximum speed limit of the tunnel into the model formula to obtain the dynamic minimum brightness value L₀ required for the tunnel middle section under this tunnel light environment. The method improves the accuracy of safety evaluation of the tunnel middle section brightness, and the method is simple and convenient, and provides a reference basis for the road traffic safety research. The invention also provides a system for implementing this method.

### TECHNICAL FIELD

This invention relates to the technical field of highway tunnel illumination, especially relates to an illumination standard calculation method and system for a tunnel middle section based on safe visual recognition.

### BACKGROUND

The middle section of road tunnel is a relatively closed structure, and is not affected by natural light. When the driver is driving in a tunnel middle section, the driver's visual and psychological burden will increase, as compared to when driving in an external environment. In order to improve the visual environment of tunnel, lighting facilities should be used in the tunnel, and a tunnel middle section brightness value which can satisfy the visual information collection requirements as well as the driving safety and comfort requirements of the driver driving a motor vehicle at a certain speed in the tunnel middle section should be provided, that is to say, a safe driving brightness level should be reached by the tunnel middle section.

In recent years, new road lighting lamps are developing quickly, and people more and more deeply focus on tunnel safety. But at present, there mainly exists the following problems: At home and abroad, the illumination standard of the tunnel middle section is made according to the light source of sodium lamp, the evaluation of illumination standards are mostly performed based on the subjective experience of a driver or an expert with qualitative assessment of the brightness of the tunnel middle section. Or it is based on the driver's psychological and physiological indicators to evaluate the safety of the tunnel middle section. There is a lack of research on illumination standards under different light source characteristics in the tunnel middle section that meets the driver's visual recognition requirements in an actual operation process. Study on the characteristics of the lighting source and visual recognition of a small target object in the tunnel middle section usually adopts a static measuring method, and indicators such as the reaction time are used in order to conduct theoretic study, which limits the selection of the characteristic indicators of the light source. So it is needed to find a simple and convenient technique to accurately calculate the illumination standard corresponding to different light source characteristics for a tunnel middle section based on safe visual recognition.

### SUMMARY OF THE INVENTION

An objective of the invention is to solve the above-mentioned technical defects existing in the prior art, by providing an illumination standard calculation method for a tunnel middle section which is reliable and easy to operate and meets the requirements of the driver's visual perception, and also by providing a system for implementing the illumination standard calculation method for different light source characteristics of a tunnel middle section based on safe visual recognition which is simple and reliable with high utilization rate, so as to overcome the technical defects that the existing illumination standards of the tunnel middle section has unreliable basis and complicated tests with results that do not take into account the driver's psychological and physiological factors.

In order to solve at least one of the above problems, a first aspect of the invention is to provide an illumination standard calculation method for a tunnel middle section based on safe visual recognition, which comprises the following steps: (a) Setting the light environment of the tunnel middle section, including setting a color temperature to be T₀, setting color rendering index to be Ra₀, and setting average brightness to be L, for the tunnel middle section; (b) Placing a target object A in the tunnel middle section, the distance between a starting point of the tunnel middle section and a position where the target object A is placed being greater than a safe stopping sight distance D₀ corresponding to a maximum speed limit of the tunnel; (c) Making a driver drive a motor vehicle at different speeds toward the target object A, and measuring a visual recognition distances D required by the driver to visually discover the target object A at different driving speeds; (d) Resetting the average illumination brightness L of the tunnel middle section and repeating the steps (b) and (c) to obtain a plurality of different sets of visual recognition distances D and corresponding average brightness values L of the tunnel middle section; (e) According to the above acquired plurality of sets of visual recognition distance D and corresponding average brightness values L of the tunnel middle section, using the S model to fit the data of the plurality of sets of D and L to obtain the relational model formula of D and L to be

$$L = \frac{0.683}{5.575 - ln ( D )} ;$$

(f) Substituting the safe stopping sight distance D₀ corresponding to the maximum speed limit of the tunnel into the model formula to obtain the dynamic minimum brightness value L₀ required for the tunnel middle section under this tunnel light environment.

Further, after the step (f), the illumination standard calculation method for a tunnel middle section based on safe visual recognition, also comprises steps to calibrate the dynamic minimum brightness value L₀ required for the tunnel middle section, and the steps are as follows: (g) The tunnel being a simulation tunnel, placing a static test target object B in the middle section of the simulation tunnel, parking the motor vehicle at a position that is spaced apart from the target object B by a distance Ds, setting the color temperature to be T₀ and the color rendering index to be Ra₀ for the tunnel middle section; (h) Letting a driver enter the cab of the motor vehicle, adjusting the average brightness L of the tunnel middle section from small to large, and recording the static minimum brightness value L_{f} required by the driver to visually discover the static test target object B; (i) resetting at least one of the color temperature and the color rendering index of the simulation tunnel middle section, repeating the step (h) to obtain static minimum brightness values L_{f} associated with a plurality of different sets of color temperatures and color rendering indexes, setting the static minimum brightness value F_{f0} associated with a color temperature T₀ and a color rendering index Ra₀ as benchmark J, and comparing the benchmark J with static minimum brightness values L_{f} associated with different color temperatures and color rendering indexes to obtain the visual calibration coefficients a associated with different color temperatures and color rendering indexes; (j) Calculating the minimum brightness value L_{0d} of the tunnel middle section under different light environments to be an arithmetic product of a and L₀.

A second aspect of the invention provides a system for implementing an illumination standard calculation method for a tunnel middle section based on safe visual recognition, comprising: a tunnel middle section subsystem that comprises illumination devices with adjustable output power installed in the tunnel middle section for setting a light environment; a test subsystem that comprises a target object placed in the tunnel middle section, a test vehicle, a brightness measuring device, a color temperature measuring device, a color rendering index measuring device, a speed measuring device, and a distance measuring device, for collecting test data; a data computing subsystem that comprises a computer system for fitting and processing the test data.

In the method and system of the invention, by combining and screening the information related to responsive driving behavior and visual recognition status towards small target object of a driver in the tunnel middle section under different light environments established by illumination devices, comprehensive safe illumination standards for the tunnel middle section that meets the safe visual recognition requirements of the driver are provided, with consideration of the driver's visual perception requirement characteristics from the driver's angle, thereby improving the accuracy of safety evaluation of the tunnel middle section brightness, with easy and convenient operation method, so as to provide a reference basis for the research of road traffic safety.

### BRIEF DESCRIPTION OF DRAWINGS

Referring to the accompanying drawings, more objectives, functions and advantages of the invention will be clarified in the following description of the embodiments of the invention wherein:

FIG. 1 is a flow chart of the method of measuring the minimum brightness value of the tunnel middle section;

FIG. 2 is a flow chart of the method of measuring the safe visual recognition threshold of the tunnel middle section;

FIG. 3 is a schematic diagram of the dynamic test of the illumination standard calculation method for a tunnel middle section based on safe visual recognition;

FIG. 4 is a schematic diagram of the static test of the illumination standard calculation method for a tunnel middle section based on safe visual recognition.

### REFERENCE NUMERALS

100 tunnel middle section
101 simulation tunnel middle section
102 illumination device
103 target object A, target object B
104 test vehicle

### DETAILED DESCRIPTION OF SPECIFIC EMBODIMENTS

### Embodiment 1

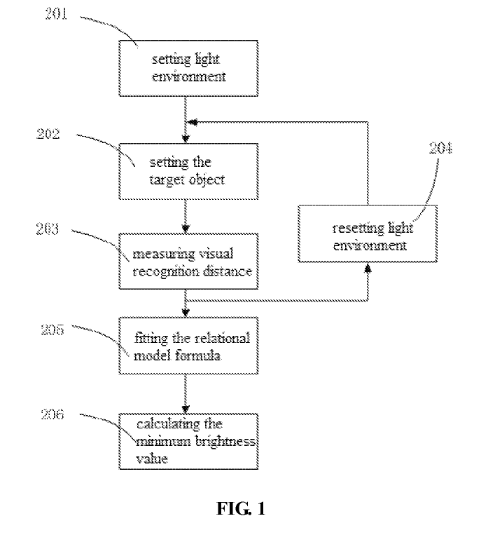

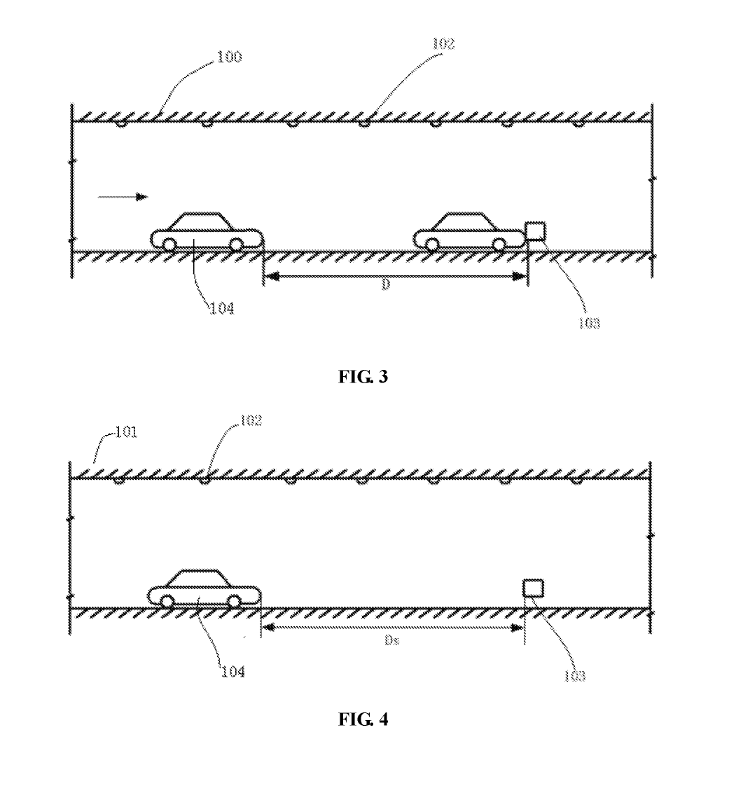

FIG. 1 shows a flow chart of the method of measuring the minimum brightness value of the tunnel middle section. FIG. 3 shows a schematic diagram of the dynamic test of the illumination standard calculation method for a tunnel middle section based on safe visual recognition. The invention provides an illumination standard calculation method for a tunnel middle section based on safe visual recognition, which calculates the minimum brightness value of the tunnel middle section that meets the safe visual recognition requirements under different light environments, so as to ensure that the driver's driving safety.

Referring to FIG. 1 and FIG. 3, the illumination standard calculation method for a tunnel middle section based on safe visual recognition provided by the invention comprises the following steps:

Step 201, setting the light environment of the tunnel middle section 100, wherein, the light environment includes the color temperature, the color rendering index and the average brightness L of the tunnel middle section 100, the light environment for illumination of the tunnel middle section 100 is set at a color temperature T₀, a color rendering index Ra₀ and an average brightness.

Step 202, placing a target object A 103 in the tunnel middle section 100, the distance between the starting point of the tunnel middle section and the position where the target object A 103 is placed is larger than the safe stopping sight distance D₀ corresponding to the maximum speed limit designed for the tunnel, so as to prepare for the driver's dynamic visual recognition experiment.

Step 203, making the driver drive the motor vehicle 104 at different speeds toward the target object A 103 direction, and measuring the visual recognition distances D required by the driver to visually discover the target object A 103 at different driving speeds; Step 204, resetting the illumination brightness value L of the tunnel middle section 100 and repeating the Steps 202 and 203, thereby obtaining a plurality of different sets of visual recognition distances D and corresponding average brightness values L of the tunnel middle section 100.

According to partial correlation analysis, the analysis found that the visual recognition distance D has low correlation with the driving speed when making the visual recognition, while having high correlation with the average brightness value L of the tunnel middle section 100. And according to the analysis, during the driving process in the tunnel middle section, as the tunnel environment is monotonous, the perception ability of the driver towards the surrounding scenery decreases, and thus the vehicle speed can not be accurately perceived, so the visual recognition distance D is less affected by the driving speed, and there is no obvious rule. Therefore, the influence of the driving speed may be not necessary to be considered.

Step 205, according to the above obtained plurality of sets of visual recognition distances D and corresponding average brightness values L of the tunnel middle section, using a data fitting mathematical model of the S model to fit the data of the plurality of sets of D and L to obtain the relational model formula of D and L to be:

$$L = \frac{0.683}{5.575 - ln ( D )} .$$

Step 206, in order to make the illumination of the tunnel middle section 100 meet the conditions for safe driving, the safe stopping sight distance D₀ corresponding to the maximum speed limit of the tunnel is substituted into the model formula to obtain the minimum brightness value L₀ required for the tunnel middle section 100 under the particular light source characteristics. This minimum brightness value provides an illumination design basis for the tunnel middle section 100.

In order to make the illumination standard calculation method of the invention more reliable and conform to the international standard, in the present embodiment of the illumination standard calculation method for the tunnel middle section 100 based on safe visual recognition in the present invention, the target object A 103 is a gray cube with a volume of 20 cm*20 cm*20 cm and a reflectivity of 20%. In order to eliminate the influence of the driver's memory of the target object position on the experimental results, in the tests, the target object position in the tunnel middle section 100 is arbitrary.

In order to simplify the illumination standard calculation method for the tunnel middle section 100 based on safe visual recognition of the invention, and in order to do measurement quickly, in this embodiment, a non-contact speed meter installed on the motor vehicle 104 is utilized. When the driver visually discovers the target object 103, the non-contact speed meter is triggered to record a first position; when this driver reaches the target object 103, a second position is recorded. The distance between the two positions is regarded as the visual recognition distance D. This can quickly measure the visual recognition distance, reduce the time for the implementation of the steps, and increase the efficiency of the implementation of the steps.

In this embodiment of the illumination standard calculation method for the tunnel middle section tunnel based on safe visual recognition of the invention, the brightness value of the tunnel middle section is measured by using a luminance meter or an illuminometer, and when using the illuminometer, it is necessary to calculate the relationship between the average brightness value and the average illumination value of the tunnel middle section, i.e., to calculate the average illumination conversion coefficient, so that the brightness value can be calculated after the illumination value is measured; the color temperature and the color rendering index of the tunnel middle section are measured by a luminance spectrophotometer.

In this embodiment of the illumination standard calculation method for the tunnel middle section based on safe visual recognition of the invention, the step of changing the illumination brightness of the tunnel middle section 100 is performed by changing the output power of the illumination device 102 in the tunnel middle section 100, without replacing the illumination device 102 in the tunnel middle section, thus it is convenient to implement the present embodiment.

In order to make the results more accord with the objective reality, in this embodiment of the illumination standard calculation method for the tunnel middle section based on safe visual recognition of the invention, a number of drivers are randomly selected at different ages, different eyesight levels within the normal range, and different driving experience.

### Embodiment 2

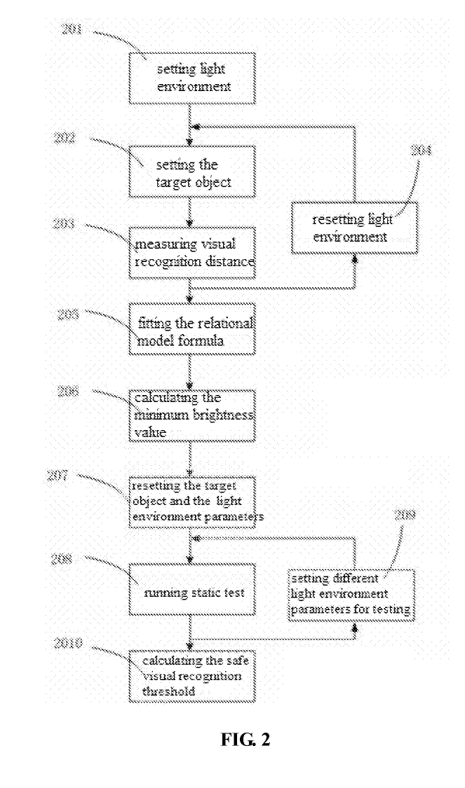

On the basis of Embodiment 1, the invention can calculate minimum brightness values of the tunnel middle section that meets the visual recognition requirements under different light environment and then obtain the safe visual recognition threshold. FIG. 2 is a flow chart of the method of measuring the safe visual recognition threshold of the tunnel middle section in Embodiment 2; FIG. 4 is a schematic diagram of the static test of the illumination standard calculation method for the tunnel middle section based on safe visual recognition.

Referring to FIG. 2 and FIG. 4, in this embodiment of the illumination standard calculation method for the tunnel middle section based on safe visual recognition of the invention, on the basis of Embodiment 1, the following steps performed by using a simulation tunnel are also included:

Step 207, placing a static test target object B 103 in the middle section of the tunnel which is a simulated tunnel 101, parking the motor vehicle at a position that is spaced apart from the static test target object B 103 by a distance Ds, and setting the color temperature to be T₀ and the color rendering index to be Ra₀ for the tunnel middle section.

In the embodiment of the present invention, if the middle section of the simulation tunnel 101 is not able to provide sufficient observation distance, and the distance Ds from the actual observation position to the static test target object B 103 may be less than the safe stopping sight distance D₀ corresponding to the maximum speed limit, then according to the principle of retinal imaging, the size C of the static test target object 103 meets the formula of

$$\frac{Ds}{{D}_{0}} = \frac{c}{20 cm} ,$$

where D₀ is the safe stopping sight distance corresponding to the maximum speed limit.

Step 208, letting the driver enter the cab of the motor vehicle 104, adjusting the average brightness L of the middle section of the simulation tunnel 101 is changed from small to large, and recording the static minimum brightness value L_{f} required by the driver to visually discover the static test target object B 103.

Step 209, resetting at least one of the color temperature and the color rendering index of the middle section of the simulation tunnel 101, repeating the Step 208 to obtain static minimum brightness values L_{f} associated with a plurality of different sets of color temperatures and color rendering indexes, setting the static minimum brightness value F_{f0} associated with a color temperature T₀ and a color rendering index Ra₀ as the benchmark J, and comparing the benchmark J with static minimum brightness values L_{f} associated with different color temperatures and color rendering indexes to obtain the visual calibration coefficients a associated with different color temperatures and color rendering indexes.

Step 2010, calculating the minimum brightness value L_{0d} of the tunnel middle section under different light environments to be an arithmetic product of a and L₀, which is the safe visual recognition threshold of the tunnel middle section.

### Embodiment 3

This embodiment of the present invention applies the method of Embodiment 1 to a test in an actual tunnel middle section. A tunnel middle section 100 of a highway in a province is selected for measurement of its safe minimum brightness value L. The freeway tunnel total length is 555 m, the maximum speed limit is 80 km/h, the light environment of the tunnel middle section has a color temperature of 5700K and a color rendering index of 70, and the road surface in the tunnel is covered with bituminous concrete. 6 motor vehicle drivers are randomly selected as test subjects. The illumination device is arranged to set different average brightness values in the tunnel. The driver is asked to drive a motor vehicle 104 at a certain speed from the outside of the tunnel toward the inside of the tunnel and try to visually recognize the front target object 103 during the driving process, with a criterion that the driver is able to easily and quickly find the target object 103, and the driver's visual recognition status towards the target object 103 is recorded.

In the visual recognition process, the visual recognition information when the driver is driving on the test section and the light environment information of the tunnel middle section are collected. According to the model of the invention, the brightness value of the tunnel middle section is calculated. Under different brightness values of the tunnel middle section, drivers try to visually recognize the target object in the tunnel middle section. A total of 30 samples were collected, and the effective samples were 24, as shown in Table 1.

TABLE 1
the dynamic visual recognition results in a tunnel middle section

| | | Driving | visual |
|---|---|---|---|
| | Brightness | speed | recognition |
| number | (cd/m²) | (km/h) | distance (m) |
| 1 | 0.59 | 60.84 | 73.76 |
| 2 | 0.70 | 65.84 | 83.38 |
| 3 | 0.90 | 80.13 | 155.92 |
| 4 | 0.96 | 79.64 | 149.20 |
| 5 | 1.08 | 74.61 | 169.03 |
| 6 | 1.09 | 80.82 | 133.27 |
| 7 | 2.49 | 55.80 | 207.77 |
| 8 | 2.49 | 85.47 | 218.36 |
| 9 | 2.49 | 72.39 | 210.72 |
| 10 | 2.49 | 97.91 | 178.38 |
| 11 | 2.49 | 102.77 | 167.44 |
| 12 | 2.49 | 110.49 | 163.93 |
| 13 | 2.61 | 116.48 | 195.11 |
| 14 | 2.75 | 118.30 | 264.62 |
| 15 | 3.15 | 92.26 | 200.47 |
| 16 | 4.33 | 64.07 | 222.68 |
| 17 | 4.33 | 60.37 | 218.91 |
| 18 | 4.33 | 55.56 | 239.08 |
| 19 | 4.33 | 63.48 | 238.04 |
| 20 | 4.33 | 73.16 | 227.80 |
| 21 | 4.33 | 81.56 | 225.13 |
| 22 | 4.33 | 79.25 | 229.39 |
| 23 | 4.77 | 74.39 | 218.02 |
| 24 | 4.77 | 90.69 | 208.36 |

After partial correlation analysis, it is found that the visual recognition distance D has low correlation with the driving speed of the motor vehicle 104, but has high correlation with the brightness L of the tunnel middle section 100. By the S model fitting, the following formula is obtained:

$$L = \frac{0.683}{5.575 - ln ( D )} . \qquad ( 1 )$$

The safe stopping sight distance D₀ corresponding to a color temperature of 5700K and a color rendering index of 70 is substituted into the formula (1) to calculate the minimum brightness value L₀ of the tunnel middle section under such a light environment associated with different maximum speed limits (60 km/h, 80 km/h, 100 km/h, 120 km/h). Referring to table 2:

TABLE 2
reasonable brightness values of the tunnel middle section

| | | | | |
|---|---|---|---|---|
| maximum speed limit (km/h) | 60 | 80 | 100 | 120 |
| safe stopping sight distance (m) | 75 | 110 | 160 | 210 |
| minimum brightness value (cd/m²) | 0.54 | 0.8 | 1.4 | 3.0 |

### Embodiment 4

Based on Embodiment 2, the present embodiment of the invention carries out a static test of the actual simulation tunnel. A simulation tunnel 101 is selected to simulate the tunnel middle section, and in this simulation tunnel, the illumination device 102 may be selected from a variety of lighting fixtures, making the tunnel light environment parameters such as average brightness, color temperature and color rendering index easier to adjust and measure. The road surface in the simulation tunnel is covered with a series of diffuse reflection materials similar to the material of a bituminous concrete road surface, which is modified asphalt waterproof coiled material.

The color temperature is related to the spectral energy distribution, and the spectral composition is the most important determinant of the color temperature of a light source. The human eye is more accustomed to the natural daytime light spectrum, and through the investigation of spectral composition of the daytime light, it is found that light close to the daytime light has a color temperature distributed in the range of 5000K-6000K. As for the current tunnel illumination device 102, the color temperature of sodium lamp is low, at about 3000K. By reference to the commonly used color temperature of the existing tunnel lamps provide by the related lighting fixture manufacturers, the color temperature of the illumination device 102 in the embodiment is selected to be at five color temperature levels of 3000K, 4000K, 5000K, 5700K, and 6500K for testing.

The color rendering index of light source is an important parameter to evaluate the color quality of a light source, which indicates the conformity extent of the color rendered for an object by illumination of the light source and the color rendered by illumination of the standard light source (sunlight). CIE stipulates the color rendering index of sunlight to be 100. In the current tunnel design, the color rendering index of the light source of the lighting fixture is not less than 70. So this experiment selects three color rendering index levels of 70, 80, and 90. By using the 5 color temperature levels and 3 color rendering index levels for experimental design, a total of 14 combinations are tested.

In this embodiment, 12 drivers with normal eyesight are randomly selected, the static visual recognition test is carried out, and the static visual recognition minimum brightness values under different light environments are collected, as presented in Table 3.

TABLE 3
the static visual recognition minimum brightness values
under different light environments

| light environment | static visual recognition minimum | | | |
|---|---|---|---|---|
| of the tunnel | brightness value (cd/m²) | | | |
| middle section | 75 m | 110 m | 160 m | 210 m |
| 6500K, 70 | 0.58 | 0.72 | 1.22 | 1.77 |
| 4000K, 80 | 0.59 | 0.75 | 1.23 | 1.95 |
| 5000K, 90 | 0.79 | 0.98 | 1.50 | 2.29 |
| 5700K, 70 | 0.82 | 1.27 | 1.63 | 2.56 |
| 3000K, 80 | 0.88 | 1.33 | 1.66 | 3.09 |
| 6500K, 80 | 0.89 | 1.40 | 1.87 | 3.10 |
| 3000K, 90 | 0.91 | 1.40 | 1.98 | 3.48 |
| 5000K, 80 | 0.92 | 1.67 | 2.32 | 3.52 |
| 3000K, 70 | 1.30 | 1.99 | 2.54 | 3.54 |
| 5700K, 90 | 1.30 | 2.18 | 2.75 | 3.56 |
| 5000K, 70 | 1.50 | 2.18 | 2.76 | 3.72 |
| 6500K, 90 | 1.53 | 2.18 | 3.13 | 4.18 |
| 5700K, 80 | 1.67 | 2.18 | 3.58 | 4.64 |
| 4000K, 70 | 1.72 | 2.43 | 3.91 | 4.84 |

The static visual recognition minimum brightness value associated with a light environment of (5700K, 70) of the tunnel middle section is set as the benchmark to calculate the visual calibration factor a. Then the dynamic visual recognition minimum brightness value, namely L_{0d}, that meets the visual recognition distance requirements under different environments are calculated. Results are shown in Table 4, which are suitable for the free flow traffic condition.

TABLE 4
Dynamic minimum brightness values of various lamps under
different maximum speed limits

| light environment | dynamic visual recognition minimum | | | |
|---|---|---|---|---|
| of the tunnel | brightness value (cd/m²) | | | |
| middle section | 60 km/h | 80 km/h | 100 km/h | 120 km/h |
| 6500K, 70 | 0.38 | 0.45 | 0.97 | 1.72 |
| 4000K, 80 | 0.39 | 0.47 | 0.97 | 1.90 |
| 5000K, 90 | 0.52 | 0.62 | 1.29 | 2.23 |
| 5700K, 70 | 0.54 | 0.80 | 1.40 | 3.00 |
| 3000K, 80 | 0.58 | 0.84 | 1.43 | 3.01 |
| 6500K, 80 | 0.59 | 0.88 | 1.60 | 3.01 |
| 3000K, 90 | 0.60 | 0.88 | 1.70 | 3.39 |
| 5000K, 80 | 0.61 | 1.05 | 1.99 | 3.42 |
| 3000K, 70 | 0.85 | 1.26 | 2.18 | 3.44 |
| 5700K, 90 | 0.86 | 1.37 | 2.36 | 3.46 |
| 5000K, 70 | 0.99 | 1.37 | 2.37 | 3.61 |
| 6500K, 90 | 1.01 | 1.38 | 2.69 | 4.07 |
| 5700K, 80 | 1.10 | 1.38 | 3.08 | 4.51 |
| 4000K, 70 | 1.13 | 1.53 | 3.36 | 4.70 |

According to the above results, the minimum brightness values L_{0d} corresponding to a particular maximum speed limit under different light environments of the tunnel middle section 100 can be designed.

### Embodiment 5

The invention also provides a system for implementing the illumination standard calculation method for a tunnel middle section based on safe visual recognition. The system includes a tunnel middle section subsystem that comprises illumination devices 102 with adjustable output power installed in the tunnel middle section 100 for setting the light environment; a test subsystem that comprises a target object 103 placed in the tunnel middle section, a test vehicle 104, a brightness measuring device, a color temperature measuring device, a color rendering index measuring device, a speed measuring device, and a distance measuring device, for dynamic testing and static testing with test data collection; and a data computing subsystem that comprises a computer system for fitting and processing the test data.

In the traditional tunnel illumination, the illumination device 102 often adopts high-pressure sodium lamps with a low color temperature. In the current tunnel design, LED and other new lighting sources are used, and these new lighting sources have selectable color temperatures and color rendering indexes. According to statistics, the light source color temperatures of tunnel lighting fixtures are mostly in the range of 3000K-6500K. When there is a transition of light from warm white to cold white, there will also be a transition from yellow light sensation to white light sensation in visual perception, and thus the driver's visual recognition ability will also be affected. The fidelity degree of color is different under different color rendering conditions, wherein, a light source with higher color rendering performance has better reproducing effect of color, and thus the color seen by the human eye is closer to the natural original color, while a light source with low color rendering performance has poorer reproducing effect of color, and thus the color seen by the human eye is deviated to a greater extent. In the current tunnel design, the light source color rendering index of the lighting fixture is required to be not less than 70.

In the system for implementing the illumination standard calculation method for a tunnel middle section based on safe visual recognition of the invention, the lighting fixture 102 adopts an LED lamp with adjustable color temperature, and in order to make the measurement convenient, the color temperature measuring device and the color rendering index measuring device are the same, being a luminance spectrophotometer.

In the system for implementing the illumination standard calculation method for a tunnel middle section based on safe visual recognition of the invention, the brightness measuring device is a luminance meter, and can also be an illuminometer, wherein the brightness value is obtained by using the relationship between illumination and brightness. For example, the average brightness value and average illumination value of the road surface is measured first, and then the road surface average illumination conversion coefficient is calculated and thus can be used in the conversion relationship between illumination and brightness, so as to obtain the brightness by measuring the illumination. In order to increase the efficiency and precision of the measurement, the speed measuring device and the distance measuring device are the same, being a non-contact speed meter.

Compared with a large bus, a small passenger car has relatively narrower field of vision. Under the same environment, it is even more difficult for drivers in a small passenger car to visually recognize the target object. According to the most unfavorable principle, the system for implementing the illumination standard calculation method for a tunnel middle section based on safe visual recognition of the invention selects a small passenger car as the motor vehicle 104.

The drawings are only schematic and not to scale. Although the present invention has been described in combination with preferred embodiments, it should be understood that the protection scope of the present invention is not limited to the embodiments described herein.

Combined with the explanation and implementation of the present invention disclosed herein, other embodiments of the present invention are easy to understand for those skilled in the art. The illustrative embodiments are considered to be exemplary, and the true scope and main concept of the present invention are defined by the appended claims.

1. An illumination standard calculation method for a tunnel middle section based on safe visual recognition, comprising the following steps:
(a) setting light environment of the tunnel middle section, including setting color temperature to be T₀, setting color rendering index to be Rₐ₀, and setting average brightness to be L, for the tunnel middle section;
(b) Placing a target object A in the tunnel middle section, the distance between a starting point of the tunnel middle section and a position where the target object A is placed being greater than a safe stopping sight distance D₀ corresponding to a maximum speed limit of the tunnel;
(c) making a driver drive a motor vehicle at different speeds toward the target object A, and measuring a visual recognition distances D required by the driver to visually discover the target object A at different driving speeds;
(d) resetting the average illumination brightness L of the tunnel middle section and repeating the steps (b) and (c) to obtain a plurality of different sets of visual recognition distances D and corresponding average brightness values L;
(e) According to the above acquired plurality of sets of visual recognition distance D and corresponding average brightness values L of the tunnel middle section, using the S model to fit the data of the plurality of sets of D and L to obtain the relational model formula of D and L to be
$$L = \frac{0.683}{5.575 - ln ( D )} ;$$
(f) substituting the safe stopping sight distance D₀ corresponding to the maximum speed limit of the tunnel into the model formula to obtain the dynamic minimum brightness value L₀ required for the tunnel middle section under this tunnel light environment.

2. The method of claim 1, wherein, after the step (f), the method further comprises the following steps:
(g) the tunnel being a simulation tunnel, placing a static test target object B in the middle section of the simulation tunnel, parking the motor vehicle at a position that is spaced apart from the target object B by a distance Ds, and setting the color temperature to be T₀ and the color rendering index to be Ra₀ for the tunnel middle section;
(h) letting a driver enter the cab of the motor vehicle, adjusting the average brightness L of the tunnel middle section from small to large, and recording the static minimum brightness value L_{f} required by the driver to visually discover the static test target object B;
(i) resetting at least one of the color temperature and the color rendering index of the middle section of the simulation tunnel, repeating the step (h) to obtain static minimum brightness values L_{f} associated with a plurality of different sets of color temperatures and color rendering indexes, setting the static minimum brightness value F_{f0} associated with a color temperature T₀ and a color rendering index Ra₀ as benchmark J, and comparing the benchmark J with static minimum brightness values L_{f} associated with different color temperatures and color rendering indexes to obtain the visual calibration coefficients a associated with different color temperatures and color rendering indexes;
(j) calculating the minimum brightness value L_{0d} of the tunnel middle section under different light environments to be an arithmetic product of a and L₀, which is the safe visual recognition threshold of the tunnel middle section.

3. The method of claim 1, wherein, the step of measuring the visual recognition distance D comprises: by using a non-contact speed meter installed on a motor vehicle, when the driver visually discovers the target object, the non-contact speed meter is triggered to record a first position;
when the driver reaches the position of the target object, a second position is recorded, and the visual recognition distance D is the distance between the two positions.

4. The method of claim 2, wherein, the size C of the static test target object B meets the formula of
$$\frac{Ds}{{D}_{0}} = \frac{c}{20 cm} ,$$
where D₀ is the safe stopping sight distance corresponding to the maximum speed limit.

5. The method of claim 1, wherein, the position of the target object A in the tunnel middle section is arbitrary; a luminance spectrophotometer is used in the step of measuring the color temperature and the color rendering index in the tunnel.

6. The method of claim 1, wherein, the step of resetting the illumination brightness of the tunnel middle section is performed by changing the illumination power of the tunnel middle section.

7. The method of claim 1, wherein, drivers are randomly selected to be distributed in a range of different ages, different driving experience and different normal eyesight; the motor vehicle is a small passenger car.

8. The method of claim 1, wherein, the step of measuring the brightness value uses a luminance meter for direct measurement, or uses an illuminometer with the help of the relationship between illumination and brightness to calculate the brightness.

9. A system for implementing an illumination standard calculation method for a tunnel middle section based on safe visual recognition, comprising:
a tunnel middle section subsystem that comprises illumination devices with adjustable output power installed in the tunnel middle section for setting a light environment;
a test subsystem that comprises a target object placed in the tunnel middle section, a test vehicle, a brightness measuring device, a color temperature measuring device, a color rendering index measuring device, a speed measuring device, and a distance measuring device, for collecting test data;
a data computing subsystem that comprises a computer system for fitting and processing the test data.

10. The system of claim 9, wherein,
in the test subsystem, the color temperature measuring device and color rendering index measuring device is a luminance spectrophotometer, the brightness measuring device is a luminance meter or an illuminometer, the distance measuring device and speed measuring device are respectively a non-contact speed meter, and the motor vehicle is a small passenger car.
